(19) United States
(12) Patent Application Publication
(10) Pub. No.: US 2012/0131491 A1
(43) Pub. Date: May 24, 2012

(54) APPARATUS AND METHOD FOR DISPLAYING CONTENT USING EYE MOVEMENT TRAJECTORY

(76) Inventor: Ho-Sub Lee, Seoul (KR)

(21) Appl. No.: 13/154,018

(22) Filed: Jun. 6, 2011

(30) Foreign Application Priority Data
Nov. 18, 2010 (KR) 10-2010-0115110

(51) Int. Cl. G06F 3/048

(52) U.S. Cl. 715/776; 715/784

(57) ABSTRACT

An apparatus and method for displaying content are provided. The apparatus tracks the movement of the eyes of a user and generates an eye movement trajectory. The generated eye movement trajectory is mapped to content that is displayed by the apparatus. The display of the apparatus is controlled based on the eye movement trajectory mapped to the content.

### CROSS-REFERENCE TO RELATED APPLICATION(S)

This application claims the benefit under 35 U.S.C. §119(a) of Korean Patent Application No. 10-2010-0115110, filed on Nov. 18, 2010, in the Korean Intellectual Property Office, the entire disclosure of which is incorporated herein by reference for all purposes.

### BACKGROUND

1. Field

The following description relates to a technique of controlling a mobile terminal that displays content.

2. Description of the Related Art

Recently, mobile terminals that are equipped with an electronic book (e-book) feature have been developed. Typically these mobile terminals are equipped with high-performance memories, central processing units (CPUs), and high-quality displays such as touch screens which can provide a variety of user experiences (UXs), in comparison to existing e-books.

E-books are virtual digital content items that are capable of being viewed with the aid of display devices, and are distinguished from printed books in terms of how a user may electronically insert a bookmark, turn pages, mark a portion of interest, and the like. For the most part, e-books in mobile terminals have been implemented as touch interfaces. Touch interfaces allow a user to view an e-book simply by touching on digital content that is displayed on the screens of the mobile terminal.

However, touch interfaces require users to manipulate touch screens with their hands and are not suitable for use when both hands are not free. For example, users may not be able to properly use e-books when they do not have the effective use of their hands for some reason such as an injury. In addition, frequent touches on touch screens may cause contamination and may s compromise the lifetime of touch screens.

### SUMMARY

In one general aspect, there is provided an apparatus for displaying content, the apparatus including an eye information detection unit configured to detect eye information that comprises a direction of movement of the eyes of a user, an eye movement/content mapping unit configured to generate an eye movement trajectory that is based on the detected eye information and to generate reading information by mapping the generated eye movement trajectory to text content, wherein the reading information indicates how and what part of the text content has been read by the user, and a content control unit configured to control the text content based on is the generated reading information.

The eye movement/content mapping unit may further generate a line corresponding to the generated eye movement trajectory and projects the generated line onto the text content.

The eye movement/content mapping unit may further project a beginning point of the generated line onto a beginning point of a row or column of the text content and project a portion of the generated line that has substantially the same direction as the text content onto the row or column of the text content.

The eye movement/content mapping unit may further project a beginning point of the generated line onto a beginning point of a row or column of the text content, divide the generated line into a first section that has substantially the same direction as the text content and a second section that does not have the same direction as the text content, project the first section onto the row or column of the text content, and, in response to an angle between the first and second sections being within a predetermined range, project the second section onto a space between the row or column of the text content and a second row or column of the text content.

The content control unit may comprise a portion-of-interest extractor configured to extract a portion of interest from the text content based on the generated reading information.

The content control unit may further comprise a transmitter configured to transmit the extracted portion of interest to another device, and an additional information provider configured to receive additional information corresponding to the extracted portion of interest and to provide the received additional information.

The content control unit may comprise a page turning controller configured to control page turning for the text content based on the generated reading information.

The content control unit may comprise a bookmark setter configured to set a bookmark in the text content based on the generated reading information.

The generated reading information may comprise a portion of the text content that was read by the user, the speed at which the portion of the text content was read by the user, and the number of times that the portion of the text content has been read by the user.

In another aspect, there is provided a method of displaying content, the method including detecting eye information comprising a direction of movement of the eyes of a user, generating an eye movement trajectory based on the detected eye information, mapping the generated eye movement trajectory to text content, generating reading information that indicates how and what part of the text content has been read by the user, based on the results of the mapping of the generated eye movement trajectory to the text content, and controlling the text content based on the generated reading information.

The mapping of the generated eye movement trajectory to the text content may comprise generating a line corresponding to the generated eye movement trajectory and projecting the generated line onto the text content.

The mapping of the generated eye movement trajectory to the text content may comprise projecting a beginning point of the generated line onto a beginning point of a row or column of the text content, and projecting a portion of the generated line that has substantially the same direction as the text content onto the row or column of the text content.

The mapping of the generated eye movement trajectory to the text content may comprise projecting a beginning point of the generated line onto a beginning point of a row or column of the text content, dividing the generated line into a first section that has substantially the same direction as the text content and a second section that does not have the same direction as the text content, projecting the first section onto the row or column of the text content, and in response to an angle between the first and second sections being within a predetermined range, projecting the second section onto a space between the row or column of the text content and a second row or column of the text content.

The controlling the text content may comprise extracting a portion of interest from the text content based on the generated reading information.

The controlling the text content may further comprise transmitting the extracted portion of interest to another device, and receiving additional information corresponding to the extracted portion of interest and providing the received additional information.

The controlling the text content may comprise controlling page turning for the text content based on the generated reading information.

The controlling the text content may comprise setting a bookmark in the text content based on the generated reading information.

The generated reading information may comprise a portion of the text content that was read by the user, the speed at which the portion of the text content was read by the user, and the number of times that the portion of the text content has been read by the user.

Other features and aspects may be apparent from the following detailed description, the drawings, and the claims.

### BRIEF DESCRIPTION OF THE DRAWINGS

FIG. 1 is a diagram illustrating an example of an exterior view of apparatus for displaying content.

FIG. 2 is a diagram illustrating an example of an apparatus for displaying content.

FIGS. 3A through 3C are diagrams illustrating examples of mapping eye movement trajectory and content.

FIG. 4 is a diagram illustrating an example of a content control unit.

FIG. 5 is a diagram illustrating an example of a content display screen.

FIG. 6 is a flowchart illustrating an example of a method of displaying content.

Throughout the drawings and the detailed description, unless otherwise described, the same drawing reference numerals should be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein may be suggested to those of ordinary skill in the art. Also, descriptions of well-known functions and constructions may be omitted for increased clarity and conciseness.

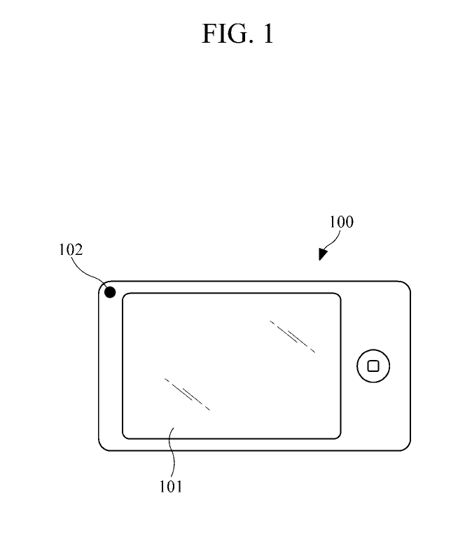

FIG. 1 illustrates an example of an exterior view of an apparatus for displaying content.

Referring to FIG. 1, apparatus 100 for displaying content may be a terminal, a mobile terminal, a computer, and the like. For example, the apparatus 100 may be an electronic book (e-book) reader, a smart phone, a portable multimedia player (PMP), an MP3 player, a personal computer, and the like.

The apparatus 100 includes a display 101 and a camera 102. The display 101 may display the content. For example, the content displayed by the display 101 may be text content. As an example, the display 101 may display content of an e-book that is stored in the apparatus 100, content of a newspaper that is received from an external source via the internet, and the like.

The camera 102 may capture an image of the eyes of a user of the apparatus 100. The shape and manner in which content is displayed by the display 101 may be controlled based on the movement of the eyes of the user which is captured by the camera 102. For example, the camera may capture the movement of the eyes of the user in real-time, and may control the shape and manner of the displayed content in real-time.

The apparatus 100 may extract a portion of content as content of interest based on the movement of the eyes of the user. For example, the apparatus 100 may extract a portion of content that the user focuses his or her reading on for a predetermined amount of time. As another example, the apparatus 100 may extract a portion of content at which the reading speed of the user slows down.

The apparatus 100 may control the turning of a page of content based on the movement of the eyes of the user. For example, if the user is reading a last part of a current page of text content, the apparatus 100 may turn to the next page of the text content.

The apparatus 100 may set a bookmark in text content based on the movement of the eyes of the user. For example, the apparatus 100 may set a bookmark at a portion of text content in which the user stops reading so that the portion may subsequently be loaded or displayed as the user resumes reading.

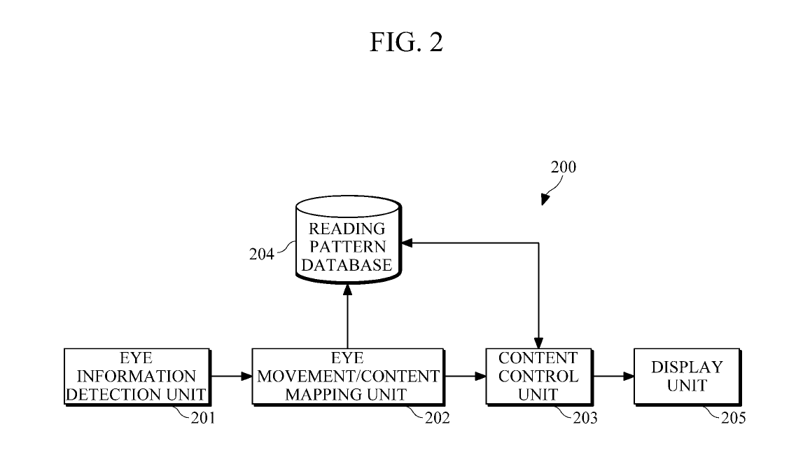

FIG. 2 illustrates an example of an apparatus for displaying content.

Referring to FIG. 2, apparatus 200 for displaying content includes an eye information detection unit 201, an eye movement/content mapping unit 202, a content control unit 203, a reading pattern database 204, and a display unit 205.

The eye information detection unit 201 may detect eye information of a user. For example, the detected eye information may include the direction of the movement of the eyes of the user, the state of the eyes of the user such as tears in the eyes of the user or the blinking of the eyes of the user, and the like. The eye information detection unit 201 may receive image data from the camera 102 that is illustrated in FIG. 1, may process the received image data, and may detect the eye information of the user from the processed image data. The eye information detection unit 201 may detect information corresponding to one eye or may detect information corresponding to both of the eyes of the user.

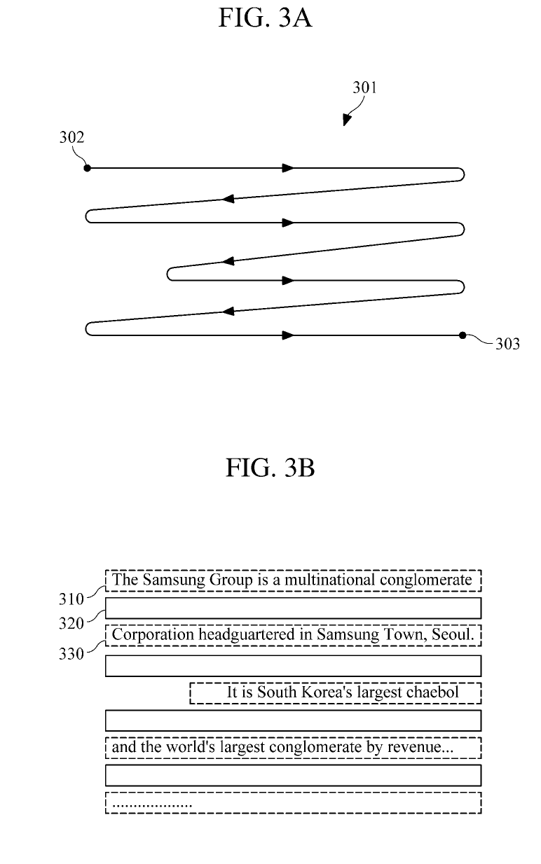

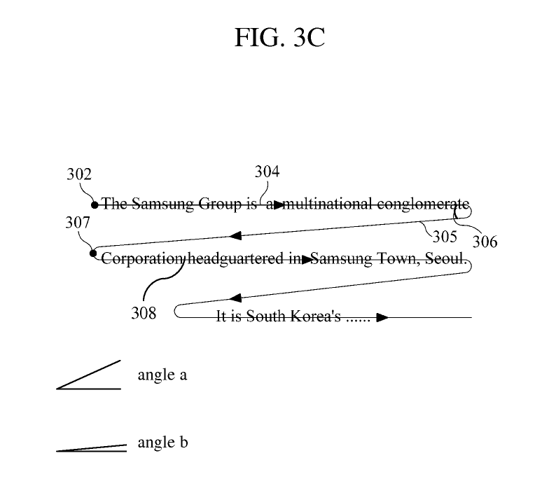

The eye movement/content mapping unit 202 may generate an eye movement trajectory based on the eye information that is provided by the eye information detection unit 201. For example, the eye movement trajectory may include traces of the movement of the eyes of the user. The eye movement/content mapping unit 202 may keep track of the movement of the eyes of the user and may generate an eye movement trajectory. For example, the eye movement trajectory 301 may be in the form of a line with a direction, as illustrated in FIG. 3A.

The eye movement/content mapping unit 202 may map the generated eye movement trajectory to text content. For example, the eye movement/content mapping unit 202 may project the eye movement trajectory 301 that is illustrated in FIG. 3A, onto text content that is illustrated in FIG. 3C.

It should be appreciated that the mapping of an eye movement trajectory and text content through projection may be performed in various manners.

As one example, the eye movement/content mapping unit 202 may map eye movement trajectory and text content based on the direction of the eye movement trajectory and the direction of the text content. For example, a portion of the eye movement trajectory that coincides in direction with rows or columns of the text content may be projected onto the rows or columns of the text content. In this example, other parts of the eye movement trajectory may be projected onto the spaces that are between the rows or columns of the text content.

As another example, the eye movement/content mapping unit 202 may divide an eye movement trajectory into one or more first sections and one or more second sections, and may map the eye movement trajectory and text content based on the angles between the one or more first sections and the one or more second sections. For example, a portion of the eye movement trajectory that coincides in direction with the text content may be classified as the first sections, and other parts of the eye movement trajectory may be classified as the second sections. As an example, if the angles between the first sections and the second sections are within a predetermined range, the first sections may be projected onto rows or columns of the text content, and the second sections may be projected onto the spaces that are between the rows or columns of the text content.

The direction of an eye movement trajectory may correspond to the direction of the movement of the eyes of the user, and the direction of text content may correspond to the direction at which the text content is written.

The eye movement/content mapping unit 202 may generate reading information. For example, the reading information may indicate how and what part of text content has been read by the user based on an eye movement trajectory mapped to the text content. For example, the reading information may include information that corresponds to a portion of text content that has been read by the user, the speed at which the portion of text content has been read by the user, and the number of times that the portion of text content has been read by the user.

The eye movement/content mapping unit 202 may store and update the reading information that is stored in the reading pattern database 204.

The content control unit 203 may control text content based on the reading information. For example, the controlling of the text content may include extracting a portion of the text content based on the reading information, displaying the extracted portion of the text content and/or information corresponding to the extracted portion of the text content on the display unit 205, setting a bookmark in the extracted portion of the text content, turning a page such that the next page is displayed on the display unit 205.

FIGS. 3A through 3C illustrate examples of mapping eye movement trajectory and content.

Referring to FIGS. 2 and 3A, the eye movement/content mapping unit 202 may generate the eye movement trajectory 301 based on eye information corresponding to a user. The eye movement trajectory 301 may be represented as a line with a direction. The eye movement trajectory 301 may correspond to the path of movement of the eyes of the user. For example, the eye movement trajectory 301 may have a beginning point 302 and an end point 303. As an example, the eye movement trajectory 301 may represent the movement of the eyes of the user from the beginning point 302 to the end point 303, as indicated by arrows. In this example, the movement of the eyes of the user is in a zigzag direction. The direction of the movement of the eyes of the user may be referred to as the direction of the eye movement trajectory 301.

Referring to FIGS. 2 and 3B, the eye movement/content mapping unit 202 may divide text content into parts such as semantic parts and non-semantic parts. The semantic parts may correspond to text such as one or more strings of symbols or characters in the text content, and the non-semantic parts may correspond to the remaining portion of the text content. The eye movement/content mapping unit 202 may detect the direction in which strings of symbols or characters in each of the semantic parts are arranged.

For example, first and second rows 310 and 330 of the text content may be classified as semantic parts, and a space 320 that is located between the first and second rows 310 and 330 may be classified as a non-semantic part. The eye movement/content mapping unit 202 may detect strings of characters that are written from the left to the right in each of the first and second rows 310 and 330. The direction that strings of symbols or characters in text content are arranged may be referred to as the direction of the text content.

Referring to FIGS. 2 and 3C, the eye movement/content mapping unit 202 may project the eye movement trajectory 301 onto the text content. For example, the eye movement/content mapping unit 202 may map the eye movement trajectory 301 and the text content based on the direction of the eye movement trajectory 301, the semantic parts of the text content, and the direction of the text content, such that the rows of text content coincide with the actual movement of the eyes of the user.

In the example of FIG. 3C, the eye movement/content mapping unit 202 divides the eye movement trajectory 301 into first sections 304 and second sections 305. The first sections 304 may be the portion of the eye movement trajectory 301 that coincide in direction with the text content, and the second sections 305 may be other portions of the eye movement trajectory 301. The eye movement/content mapping unit 202 may project the first sections 304 onto the semantic parts of the text content, and may project the second sections 305 onto the non-semantic parts of the text content. For example, the eye movement/content mapping unit 202 may align beginning point 302 of first section 304 with the beginning point of the first row of the text content to map the first section 304 and the first row of the text content.

The eye movement/content mapping unit 202 may determine whether an angle 306 between the first section 304 and a second section 305 is within a predetermined range. The range may be, for example, a range of angle a and angle b. If the angle 306 is within the predetermined range of angle a and angle b, it may be determined that the user is reading the second row of the text content. Accordingly, the first section 308 may be projected onto the second row of the text content by aligning a beginning point 307 of a first section 308 with the beginning point of the second row of the text content.

If the angle 306 is less than angle a, it may be determined that the user is reading the first row of the text content again, and the eye movement trajectory 301 may be projected onto the text content by aligning the beginning point 307 of the first section 308 with the beginning point of the first row of the text content. If the angle 306 is greater than angle b, it may be determined that the user is skipping some of the text content, and the eye movement trajectory 301 may be projected onto the text content by aligning the beginning point 307 of the first section 308 with the beginning point of a projected row (e.g., a third row) behind the second row of the text content.

As described in the examples of FIGS. 3A, 3B, and 3C, the eye movement/content mapping unit 202 may generate an eye movement trajectory, may generate reading information indicating how and what part of text content has been read by a user by mapping the eye movement trajectory to the text content, and may store the reading information. The eye movement/content mapping unit 202 may continue to update the stored reading information to reflect any variation in the reading habit or pattern of the user.

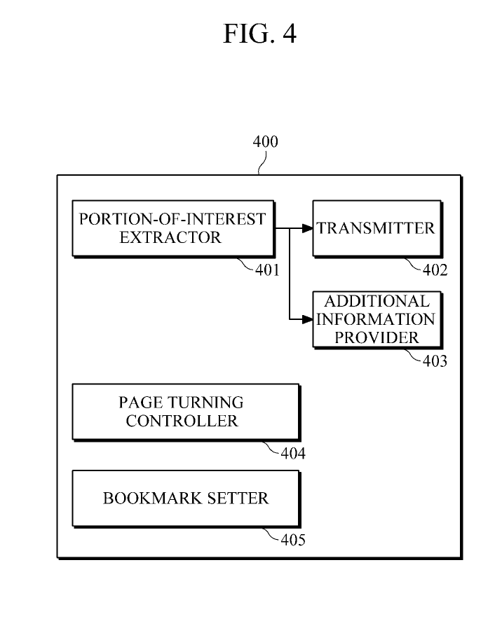

FIG. 4 illustrates an example of a content control unit.

Referring to FIG. 4, content control unit 400 includes a portion-of-interest extractor 401, a transmitter 402, an additional information provider 403, a page turning controller 404, and a bookmark setter 405.

The portion-of-interest extractor 401 may extract a portion of interest from text content based on reading information corresponding to the text content. For example, the portion-of-interest extractor 401 may extract a portion of interest based on the speed at which the text content is read by the user, the number of times the text content is read by the user, a variation in the state of the eyes of the user, and the like. As an example, the portion of interest may include a portion of the text content that receives more attention from the user and a portion of the text content that receives less attention from the user.

The portion-of-interest extractor 401 may extract as a portion of interest a portion of the text content at which the reading speed of the user decreases below a threshold value. For example, the reading speed of the user may be determined based on the amount of time the user takes to read a sentence and the length of the sentence.

The portion-of-interest extractor 401 may extract as a portion of interest a portion of the text content that is read by the user more than a predetermined number of times. For example, the portion-of-interest extractor 401 may extract as a portion of interest a portion of the text content including a sentence or word that is covered more than one time by an eye movement trajectory of the user.

The portion-of-interest extractor 401 may extract as a portion of interest a portion of the text content at which the eyes of the user are placed in a predetermined state. For example, the portion-of-interest extractor 401 may extract as a portion of interest a portion of the text content at which the eyes of the user become filled with tears or the eyelids of the user tremble.

As another example, the portion-of-interest extractor 401 may extract as a portion of interest a portion of the text content that is yet to be covered by the eye movement trajectory of the user.

The transmitter 402 may transmit the portion of interest that is extracted by the portion-of-interest extractor 401 to another device. As one example, the transmitter 402 may upload or scrap the portion of interest that is extracted by the portion-of-interest extractor 401 to a social network service (SNS) website. As another example, the transmitter 402 may transmit the portion of interest that is extracted by the portion-of-interest extractor 401 to a predetermined email account.

The additional information provider 403 may provide the user with additional information corresponding to the portion of interest that is extracted by the portion-of-interest extractor 401. For example, the additional information provider 403 may generate a query that is relevant to the portion of interest that is extracted by the portion-of-interest extractor 401 and may transmit the query to a search server. In this example, the search server may search for information that corresponds to the portion of interest extracted by the portion-of-interest extractor 401 based on the query transmitted by the additional information provider 403. The additional information provider 403 may receive the information that corresponds to the portion of interest that is extracted by the portion-of-interest extractor 401 from the search server and may display the received information along with the portion of interest that is extracted by the portion-of-interest extractor 401.

If it is determined that the user finishes reading a current page of the text content, the page turning controller 404 may turn the page so that a subsequent page of the text content is displayed. As one example, if the eye movement trajectory of the user reaches the end of the current page or reaches the right lower corner of a display screen on which the text content is being displayed, the page turning controller 404 may display the subsequent page. As another example, a certain amount of the current page is covered by the eye movement trajectory of the user, for example, if approximately 90-95% of the current page is covered by the eye movement trajectory of the user, the page turning controller 404 may turn the page to the subsequent page.

The bookmark setter 405 may set a bookmark in the text content based on the reading information corresponding to the text content. As one example, the bookmark setter 405 may set a bookmark at a portion of the text content at which the eye movement trajectory of the user ends. As another example, the bookmark setter 405 may set a bookmark in the portion of interest that is extracted by the portion-of-interest extractor 401.

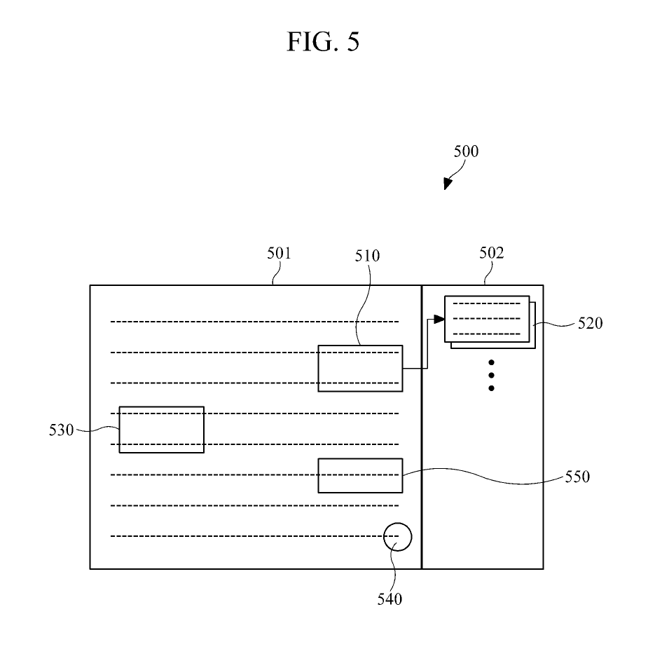

FIG. 5 illustrates an example of a display screen of an apparatus for displaying content.

Referring to FIG. 5, display screen 500 includes a content display area 501 and an additional information display area 502.

Text content may be displayed in the content display area 501. In this example, a portion 510 of the text content that is determined to be read by a user at low speed or more than one time by the user may be extracted as a portion of interest. The extracted text content may be determined based on an eye movement trajectory of the user of the apparatus for displaying content. The portion of interest 510 may be highlighted. The portion of interest 510 may be displayed in the additional information display area 502. Additional information corresponding to the portion of interest 510 may also be displayed in the additional information display area 502 along with the portion of interest 510.

As another example, a portion 530 of the text content that is skipped by the user may be extracted as a portion of interest. If the eye movement trajectory of the user reaches an end 540 of a current page of the text content, page turning may be performed so that a subsequent page is displayed.

If the user stops reading the text content at a portion 550 of the text content, a bookmark may be set at the portion 550. The portion 550 may be stored in such a way so that it may be retrieved at any time in the future by the user.

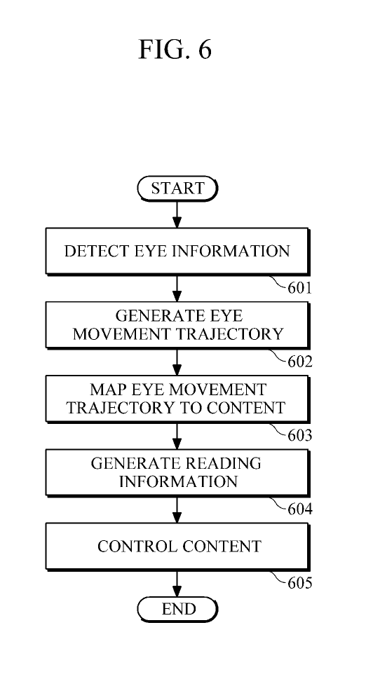

FIG. 6 illustrates an example of a method of displaying content.

Referring to FIGS. 2 and 6, the apparatus 200 detects eye information, in 601. For example, the eye information detection unit 201 may detect eye information such as the movement of the eyes of the user, the direction of the movement of the eyes of the user, the state of the eyes of the user, and the like, from an image of the eyes of a user captured in real time.

The apparatus 200 generates an eye movement trajectory, in 602. For example, the eye movement/content mapping unit 202 may generate an eye movement trajectory (e.g., the eye movement trajectory 301) in the form of a line, as illustrated in the example shown in FIG. 3A.

The apparatus 200 maps the generated eye movement trajectory to text content, in 603. For example, the eye movement/content mapping unit 202 may project a line that corresponds to the generated eye movement trajectory onto the text content, as illustrated in the example shown in FIG. 3C.

The apparatus 200 generates reading information, in 604. For example, the eye movement/content mapping unit 202 may generate reading information indicating how and what part of the text content has been read by the user based on the eye movement trajectory mapped to the text content. The generated reading information may be stored and updated.

The apparatus 200 controls the text content based on the generated reading information, in 605. For example, the content control unit 203 may control the display of the text content to extract of a portion of interest from the text content, to transmit the portion of interest, to provide additional information corresponding to the portion of interest, to turn a page, to set a bookmark, and the like.

As described above, it is possible to map an eye movement trajectory of a user to content and to control the display of the content based on the eye movement trajectory mapped to the content. Accordingly, it is possible to effectively control an apparatus for displaying content.

The processes, functions, methods, and/or software described herein may be recorded, stored, or fixed in one or more computer-readable storage media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules that are recorded, stored, or fixed in one or more computer-readable storage media, in order to perform the operations and methods described above, or vice versa. In addition, a computer-readable storage medium may be distributed among computer systems connected through a network and computer-readable codes or program instructions may be stored and executed in a decentralized manner.

As a non-exhaustive illustration only, the terminal device described herein may refer to mobile devices such as a cellular phone, a personal digital assistant (PDA), a digital camera, a portable game console, an MP3 player, a portable/personal multimedia player (PMP), a handheld e-book, a portable lab-top personal computer (PC), a global positioning system (GPS) navigation, and devices such as a desktop PC, a high definition television (HDTV), an optical disc player, a setup box, and the like, capable of wireless communication or network communication consistent with that disclosed herein.

A computing system or a computer may include a microprocessor that is electrically connected with a bus, a user interface, and a memory controller. It may further include a flash memory device. The flash memory device may store N-bit data via the memory controller. The N-bit data is processed or will be processed by the microprocessor and N may be 1 or an integer greater than 1. Where the computing system or computer is a mobile apparatus, a battery may be additionally provided to supply operation voltage of the computing system or computer.

It should be apparent to those of ordinary skill in the art that the computing system or computer may further include an application chipset, a camera image processor (CIS), a mobile Dynamic Random Access Memory (DRAM), and the like. The memory controller and the flash memory device may constitute a solid state drive/disk (SSD) that uses a non-volatile memory to store data.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for displaying content, the apparatus comprising:
an eye information detection unit configured to detect eye information that comprises a direction of movement of the eyes of a user;
an eye movement/content mapping unit configured to generate an eye movement trajectory that is based on the detected eye information and to generate reading information by mapping the generated eye movement trajectory to text content, wherein the reading information indicates how and what part of the text content has been read by the user; and
a content control unit configured to control the text content based on the generated reading information.

2. The apparatus of claim 1, wherein the eye movement/content mapping unit further generates a line corresponding to the generated eye movement trajectory and projects the generated line onto the text content.

3. The apparatus of claim 2, wherein the eye movement/content mapping unit further projects a beginning point of the generated line onto a beginning point of a row or column of the text content and projects a portion of the generated line that has substantially the same direction as the text content onto the row or column of the text content.

4. The apparatus of claim 2, wherein the eye movement/content mapping unit further projects a beginning point of the generated line onto a beginning point of a row or column of the text content, divides the generated line into a first section that has substantially the same direction as the text content and a second section that does not have the same direction as the text content, projects the first section onto the row or column of the text content, and, in response to an angle between the first and second sections being within a predetermined range, projects the second section onto a space between the row or column of the text content and a second row or column of the text content.

5. The apparatus of claim 1, wherein the content control unit comprises a portion-of-interest extractor configured to extract a portion of interest from the text content based on the generated reading information.

6. The apparatus of claim 5, wherein the content control unit further comprises:
a transmitter configured to transmit the extracted portion of interest to another device; and
an additional information provider configured to receive additional information corresponding to the extracted portion of interest and to provide the received additional information.

7. The apparatus of claim 1, wherein the content control unit comprises a page turning controller configured to control page turning for the text content based on the generated reading information.

8. The apparatus of claim 1, wherein the content control unit comprises a bookmark setter configured to set a bookmark in the text content based on the generated reading information.

9. The apparatus of claim 1, wherein the generated reading information comprises a portion of the text content that was read by the user, the speed at which the portion of the text content was read by the user, and the number of times that the portion of the text content has been read by the user.

10. A method of displaying content, the method comprising:
detecting eye information comprising a direction of movement of the eyes of a user;
generating an eye movement trajectory based on the detected eye information;
mapping the generated eye movement trajectory to text content;
generating reading information that indicates how and what part of the text content has been read by the user, based on the results of the mapping of the generated eye movement trajectory to the text content; and
controlling the text content based on the generated reading information.

11. The method of claim 10, wherein the mapping of the generated eye movement trajectory to the text content comprises generating a line corresponding to the generated eye movement trajectory and projecting the generated line onto the text content.

12. The method of claim 11, wherein the mapping of the generated eye movement trajectory to the text content comprises:
projecting a beginning point of the generated line onto a beginning point of a row or column of the text content; and
projecting a portion of the generated line that has substantially the same direction as the text content onto the row or column of the text content.

13. The method of claim 11, wherein the mapping of the generated eye movement trajectory to the text content comprises:
projecting a beginning point of the generated line onto a beginning point of a row or column of the text content;
dividing the generated line into a first section that has substantially the same direction as the text content and a second section that does not have the same direction as the text content;
projecting the first section onto the row or column of the text content; and
in response to an angle between the first and second sections being within a predetermined range, projecting the second section onto a space between the row or column of the text content and a second row or column of the text content.

14. The method of claim 10, wherein the controlling the text content comprises extracting a portion of interest from the text content based on the generated reading information.

15. The method of claim 14, wherein the controlling the text content further comprises:
transmitting the extracted portion of interest to another device; and
receiving additional information corresponding to the extracted portion of interest and providing the received additional information.

16. The method of claim 10, wherein the controlling the text content comprises controlling page turning for the text content based on the generated reading information.

17. The method of claim 10, wherein the controlling the text content comprises setting a bookmark in the text content based on the generated reading information.

18. The method of claim 10, wherein the generated reading information comprises a portion of the text content that was read by the user, the speed at which the portion of the text content was read by the user, and the number of times that the portion of the text content has been read by the user.
